(19) United States
(12) Patent Application Publication
(10) Pub. No.: US 2015/0072901 A1
(43) Pub. Date: Mar. 12, 2015

(54) LOST CIRCULATION AND FLUID LOSS MATERIALS CONTAINING GUAR CHAFF AND METHODS FOR MAKING AND USING SAME

(71) Applicant: CLEARWATER INTERNATIONAL LLC, Houston, TX (US)

(72) Inventors: Mathew M. Samuel, Houston, TX (US); Gaston W. Curtis, Houston, TX (US); Shawn Lu, Houston, TX (US)

(73) Assignee: CLEARWATER INTERNATIONAL LLC, Houston, TX (US)

(21) Appl. No.: 14/476,937

(22) Filed: Sep. 4, 2014

Related U.S. Application Data
(60) Provisional application No. 61/875,145, filed on Sep. 9, 2013.

(51) Int. Cl. C09K 8/08

(52) U.S. Cl. CPC C09K 8/08; C09K 2208/04
USPC 507/104; 507/110

(57) ABSTRACT

A lost circulation additive including a guar chaff material. The method of forming a lost circulation fluid includes contacting the lost circulation additive with a base fluid. The method for treating a formation including injecting the loss circulation fluid into a wellbore.

### RELATED APPLICATIONS

This application claims priority to and the benefit of U.S. Provisional Patent Application Ser. No. 61/875,145 filed 9 Sep. 2013.

### BACKGROUND OF THE INVENTION

1. Field of the Invention

Embodiments of the present invention relate to lost circulation additives, to lost circulation treatment fluids made therefrom, to methods of minimizing lost circulation in a well.

In particular, embodiments of the present invention relate to lost circulation additives comprising guar chaff lost circulation material (LCM) or mixtures of guar chaff LCMs, to lost circulation treatment fluids made therefrom, to methods of minimizing lost circulation in a well using such fluids.

2. Description of the Related Art

Subterranean oil and/or gas wells are generally drilled using rotary drilling techniques and circulating fluids through tubular drill pipe through the drilling equipment acting as a lubricant and to sweep away the cuttings from the cutter head and to transport them to the surface with the fluid for separation.

Drilling fluids may be either water-based employing fresh water, salt water, brines, or oil-in-water emulsions (i.e., water forms the continuous phase) or oil-based employing a relatively pure oil such as crude petroleum oil or diesel oil, or “invert” emulsions, a water-in-oil emulsions in which oil forms the continuous phase or a synthetic base employing a polymer. Drilling fluids may also include clays and/or other dispersed solids and/or suspending solids to augment rheological properties to the drilling fluids and to impart desired thixotropic properties to the drilling fluid. Clays and other dispersants also serve to coat the walls of the well with a relatively impermeable sheath, commonly termed a filter cake, which retards the flow of drilling fluid from the well into the surrounding subterranean formations. Drilling fluids may also contain one or more weighting agents designed to increase the density of the drilling fluid.

A common problem encountered during rotary drilling operations involves lost circulation in which part or all of the drilling fluid is not returned to the surface. Loss may be low, moderate, or high, where all or substantially all the fluid is lost during drilling. When a formation zone is identified in which unacceptably large amounts of drilling fluid is lost as so-called a “loss zone” or “loss circulation zone.”

Over the years, numerous techniques have been developed to prevent or reduce loss circulation. In low to moderate loss cases, one common technique to combat loss circulation is to add loss circulation agents to the drilling fluids, where the additives reduce loss of drilling fluids during drilling. Generally, loss circulation agents are synthetic polymeric thickening agents such as partially hydrolyzed polyacrylamide, polyelectrolite such as an ionic polysaccharide, various gums such as locust bean gum and guar gum, various starches, and carboxymethylcellulose (CMC) or carboxyethylcellulose (CEC).

In high loss cases, bulk materials are added to the drilling fluid to reduce or prevent loss circulation. These bulk materials are commonly referred to as “loss (or lost) circulation additives”, such as fibrous, flake (or laminated), and granular materials.

There are numerous examples of patents teaching the use of various types of materials for use as lost circulation additives in drill fluids. The following are not an exhaustive sampling. U.S. Pat. No. 2,610,149, issued Sep. 9, 1952, to Van Dyke, discloses the use of corn stalks, wood shavings, flake cellophane and chopped up paper in drilling fluids. U.S. Pat. No. 2,779,417, issued Jan. 29, 1957, to Clark et al., discloses the use of cellophane, rice hulls and shredded paper as bridging agents in a well fluid. U.S. Pat. No. 4,247,403, issued Jan. 27, 1981, to Foley et al., discloses the use of whole corncobs or the woody ring portion of corncobs as lost circulation additives for drilling fluids. U.S. Pat. No. 4,474,665, issued Oct. 2, 1984 to Green, discloses a lost circulation material useful in drilling fluids formed from cocoa bean shell material having a particle size distribution from 2 to 100 mesh. U.S. Pat. No. 4,579,668, issued Apr. 1, 1986 to Messenger, discloses for use as drilling fluid bridging agents, ground walnut shells, cellophane and shredded wood. U.S. Pat. No. 5,004,553, issued Apr. 2, 1991, and U.S. Pat. No. 5,071,575, issued Dec. 10, 1991, both to House et al., disclose a well working composition containing oat hulls and optionally including one or more of ground corn cobs, cotton, citrus pulp, and ground cotton burrs. U.S. Pat. No. 5,076,944, issued Dec. 31, 1991 to Cowan et al., discloses a seepage loss additive comprising ground cotton burrs in combination with one or more of ground oat hulls, ground corn cobs, cotton, ground citrus pulp, ground peanut shells, ground rice hulls, and ground nut shells. U.S. Pat. No. 5,118,664, issued Jun. 2, 1992, and U.S. Pat. No. 5,599,776, issued Feb. 4, 1997, both to Burts, Jr., disclose the use of various comminuted plant materials as lost circulation materials. U.S. Pat. No. 4,957,166, issued Sep. 18, 1990 to Sydansk, discloses the use of a water soluble carboxylate crosslinking polymer along with a chromic carboxylate complex crosslinking agent as a lost circulation material. U.S. Pat. No. 5,377,760, issued Jan. 3, 1995 to Merrill discloses addition of fibers to an aqueous solution of partially hydrolyzed polyacrylamide polymer, with subsequent injection into the subterranean to improve conformance. U.S. Pat. No. 7,902,126, issued Mar. 8, 2011, to Burts, Jr., disclose the use of water soluble crosslinkable polymer, a crosslinking agent, and a reinforcing material of fibers and/or various comminuted plant materials as lost circulation materials.

While numerous lost circulation additives are known, there remains a need in the art for new low cost lost circulation additives for downhole fluids.

### SUMMARY OF THE INVENTION

Embodiments of this invention provide innovations in lost circulation additives and lost circulation additives in water soluble polymer systems.

Embodiments of this invention provide a lost circulation additive comprising a dry mixture comprising a guar chaff material or a plurality of guar chaff materials. In certain embodiments, the guar chaff material comprises a mixture of fine, medium and coarse guar chaff materials.

Embodiments of this invention provide a drilling fluid including a lost circulation additive comprising an effective amount of a dry mixture comprising a guar chaff material or a plurality of guar chaff materials. In certain embodiments, the guar chaff material comprises a mixture of fine, medium and coarse guar chaff materials.

Embodiments of this invention provide methods for forming a lost circulation fluid. The methods include contacting a lost circulation additive of this invention with water or other aqueous solutions.

Embodiments of this invention provide methods of preventing lost circulation including contacting a lost circulation additive of this invention with water or an aqueous solution to form a lost circulation fluid and injecting the lost circulation fluid into a formation.

In certain embodiments, the present invention provides loss circulation additives comprising a guar chaff material having a particle size distribution designed to effectively reduce or prevent loss circulation or effectively reduce or prevent fluid loss into a formation. In certain embodiments, the guar chaff material comprises a fine guar chaff material, a medium guar chaff material, a coarse guar chaff material or mixtures and combinations thereof, where the fine guar chaff material has a particle size distribution of particles between about 0.5 μm to about 400 μm, the medium guar chaff material has a particle size distribution of particles between about 1 μm to about 700 μm, and the coarse guar chaff material has a particle size distribution of particles between about 100 μm to about 2000 μm. In other embodiments, the additives further comprises a viscosity building additive with or without a crosslinking agent. In other embodiments, the viscosity building additive comprising a crosslinkable polymer or a plurality of crosslinkable polymers. In other embodiments, the viscosity building additive comprises a polyhydroxy polymer or a plurality of polyhydroxy polymers and the crosslinking agent comprise a boron containing compound, a zirconium containing compound, an aluminum containing compound, a chromic containing compound, a titanium containing compound or a mixture thereof. In other embodiments, the additive further comprise a base fluid selected from the group consisting of an aqueous base fluid, an oil-in-water emulsion base fluid, an oil-based base fluid, an inverted emulsion base fluid, or a water-in-oil emulsion base fluid. In other embodiments, the additives are flexible, soften over time, and/or disintegrate over time. In other embodiments, the fluid loss properties are due to viscosity of the resulting fluid or particle size and shape of the additive. In other embodiments, the additives have a flake like structure, a portion of the additives are hydratable, and/or the additives comprise cellulose from the guar seed cover and galactomannan. In other embodiments, the additives further comprise proteins. In other embodiments, the proteins are crosslinkable. In other embodiments, the additives are environmental friendly. In other embodiments, the additives are light weight material and reduce a specific gravity of a drilling fluid for underbalanced drilling fluids. In other embodiments, the additives further comprise other loss circulation materials selected from the group consisting of walnut shells, cellophane flakes, and mixtures thereof. In other embodiments, the additives are dry powders, solutions in a base fluid, or slurries in a base fluid. In other embodiments, the base fluid including mineral oil, diesel, water, surfactant solutions, polymer gels, and/or brines. In other embodiments, the additives, in solid form is capable of being metered using dry add equipment or in liquid form is capable of being metered using liquid add pumps.

In certain embodiments, the present invention provides methods of forming a lost circulation fluid comprising the steps of providing a lost circulation additive comprising a guar chaff material having a particle size distribution designed to effectively reduce or prevent loss circulation or effectively reduce or prevent fluid loss into a formation; and contacting the lost circulation additive with a base fluid to form the lost circulation fluid, where the lost circulation additive is designed to effectively reduce or prevent loss circulation or effectively reduce or prevent fluid loss into a formation. In certain embodiments, the guar chaff material comprises a fine guar chaff material, a medium guar chaff material, a coarse guar chaff material or mixtures and combinations thereof, where the fine guar chaff material has a particle size distribution of particles between about 0.5 μm to about 400 μm, the medium guar chaff material has a particle size distribution of particles between about 1 μm to about 700 μm, and the coarse guar chaff material has a particle size distribution of particles between about 100 μm to about 2000 μm. In other embodiments, the additives further comprises a viscosity building additive with or without a crosslinking agent. In other embodiments, the viscosity building additive comprising a crosslinkable polymer or a plurality of crosslinkable polymers. In other embodiments, the viscosity building additive comprises a polyhydroxy polymer or a plurality of polyhydroxy polymers and the crosslinking agent comprise a boron containing compound, a zirconium containing compound, an aluminum containing compound, a chromic containing compound, a titanium containing compound or a mixture thereof. In other embodiments, the additive further comprise a base fluid selected from the group consisting of an aqueous base fluid, an oil-in-water emulsion base fluid, an oil-based base fluid, an inverted emulsion base fluid, or a water-in-oil emulsion base fluid. In other embodiments, the additives are flexible, soften over time, and/or disintegrate over time. In other embodiments, the fluid loss properties are due to viscosity of the resulting fluid or particle size and shape of the additive. In other embodiments, the additives have a flake like structure, a portion of the additives are hydratable, and/or the additives comprise cellulose from the guar seed cover and galactomannan. In other embodiments, the additives further comprise proteins. In other embodiments, the proteins are crosslinkable. In other embodiments, the additives are environmental friendly. In other embodiments, the additives are light weight material and reduce a specific gravity of a drilling fluid for underbalanced drilling fluids. In other embodiments, the additives further comprise other loss circulation materials selected from the group consisting of walnut shells, cellophane flakes, and mixtures thereof. In other embodiments, the additives are dry powders, solutions in a base fluid, or slurries in a base fluid. In other embodiments, the base fluid including mineral oil, diesel, water, surfactant solutions, polymer gels, and/or brines. In other embodiments, the additives, in solid form is capable of being metered using dry add equipment or in liquid form is capable of being metered using liquid add pumps.

In certain embodiments, the present invention provides methods of using a lost circulation fluid comprising the steps of preparing a loss circulation fluid comprising a loss circulation additive comprising a guar chaff material having a particle size distribution designed to effectively reduce or prevent loss circulation or effectively reduce or prevent fluid loss into a formation; and circulating the loss circulation fluid downhole to effectively reduce or prevent loss circulation or effectively reduce or prevent fluid loss into a formation. In certain embodiments, the guar chaff material comprises a fine guar chaff material, a medium guar chaff material, a coarse guar chaff material or mixtures and combinations thereof, where the fine guar chaff material has a particle size distribution of particles between about 0.5 μm to about 400 μm, the medium guar chaff material has a particle size distribution of particles between about 1 μm to about 700 μm, and the coarse guar chaff material has a particle size distribution of particles between about 100 μm to about 2000 μm. In other embodiments, the additives further comprises a viscosity building additive with or without a crosslinking agent. In other embodiments, the viscosity building additive comprising a crosslinkable polymer or a plurality of crosslinkable polymers. In other embodiments, the viscosity building additive comprises a polyhydroxy polymer or a plurality of polyhydroxy polymers and the crosslinking agent comprise a boron containing compound, a zirconium containing compound, an aluminum containing compound, a chromic containing compound, a titanium containing compound or a mixture thereof. In other embodiments, the additive further comprise a base fluid selected from the group consisting of an aqueous base fluid, an oil-in-water emulsion base fluid, an oil-based base fluid, an inverted emulsion base fluid, or a water-in-oil emulsion base fluid. In other embodiments, the additives are flexible, soften over time, and/or disintegrate over time. In other embodiments, the fluid loss properties are due to viscosity of the resulting fluid or particle size and shape of the additive. In other embodiments, the additives have a flake like structure, a portion of the additives are hydratable, and/or the additives comprise cellulose from the guar seed cover and galactomannan. In other embodiments, the additives further comprise proteins. In other embodiments, the proteins are crosslinkable. In other embodiments, the additives are environmental friendly. In other embodiments, the additives are light weight material and reduce a specific gravity of a drilling fluid for underbalanced drilling fluids. In other embodiments, the additives further comprise other loss circulation materials selected from the group consisting of walnut shells, cellophane flakes, and mixtures thereof. In other embodiments, the additives are dry powders, solutions in a base fluid, or slurries in a base fluid. In other embodiments, the base fluid including mineral oil, diesel, water, surfactant solutions, polymer gels, and/or brines. In other embodiments, the additives, in solid form is capable of being metered using dry add equipment or in liquid form is capable of being metered using liquid add pumps.

### BRIEF DESCRIPTION OF THE DRAWINGS

The invention can be better understood with reference to the following detailed description together with the appended illustrative drawings in which like elements are numbered the same:

FIG. 1 depicts a plot of a particle size distribution of a fine guar composition.

FIG. 2 depicts a plot of a particle size distribution of a medium guar composition.

FIG. 3 depicts a plot of a particle size distribution of a coarse guar composition.

FIG. 4 depicts 3.0 ppb of a fine guar chaff, Guar LVG, in tap water Brookfield Viscometer Results.

FIG. 5 depicts 3.0 ppb a premium-grade guar gum gelling agent such as WGA 15 in tap water Brookfield Viscometer Results.

### DEFINITIONS USED IN THE INVENTION

The term “substantially” means that the property is within 80% of its desired value. In other embodiments, “substantially” means that the property is within 90% of its desired value. In other embodiments, “substantially” means that the property is within 95% of its desired value. In other embodiments, “substantially” means that the property is within 99% of its desired value. For example, the term “substantially complete” as it relates to a coating, means that the coating is at least 80% complete. In other embodiments, the term “substantially complete” as it relates to a coating, means that the coating is at least 90% complete. In other embodiments, the term “substantially complete” as it relates to a coating, means that the coating is at least 95% complete. In other embodiments, the term “substantially complete” as it relates to a coating, means that the coating is at least 99% complete.

The term “substantially” means that a value is within about 10% of the indicated value. In certain embodiments, the value is within about 5% of the indicated value. In certain embodiments, the value is within about 2.5% of the indicated value. In certain embodiments, the value is within about 1% of the indicated value. In certain embodiments, the value is within about 0.5% of the indicated value.

The term “about” means that the value is within about 10% of the indicated value. In certain embodiments, the value is within about 5% of the indicated value. In certain embodiments, the value is within about 2.5% of the indicated value. In certain embodiments, the value is within about 1% of the indicated value. In certain embodiments, the value is within about 0.5% of the indicated value.

The term “drilling fluids” refers to any fluid that is used during well drilling operations including oil and/or gas wells, geo-thermal wells, water wells or other similar wells.

An over-balanced drilling fluid means a drilling fluid having a circulating hydrostatic density (pressure) that is greater than the formation density (pressure).

An under-balanced and/or managed pressure drilling fluid means a drilling fluid having a circulating hydrostatic density (pressure) lower or equal to a formation density (pressure). For example, if a known formation at 10,000 ft (True Vertical Depth—TVD) has a hydrostatic pressure of 5,000 psi or 9.6 lbm/gal, an under-balanced drilling fluid would have a hydrostatic pressure less than or equal to 9.6 lbm/gal. Most under-balanced and/or managed pressure drilling fluids include at least a density reduction additive. Other additives may be included such as corrosion inhibitors, pH modifiers and/or a shale inhibitors.

The term “mole ratio” or “molar ratio” means a ratio based on relative moles of each material or compound in the ratio.

The term “weight ratio” means a ratio based on relative weight of each material or compound in the ratio.

The term “mole %” means mole percent.

The term “vol. %” means volume percent.

The term “wt. %” means weight percent.

The term “SG” means specific gravity.

The term “oppositely charged surfactant” means that the surfactant has a charge opposite the polymer is sometimes called herein the “counterionic surfactant.” By this we mean a surfactant having a charge opposite that of the polymer.

The term “foamable” means a composition that when mixed with a gas forms a stable foam.

The term “ionically coupled gel” means a gel formed from the interaction between a charged polymers and oppositely charged surfactants.

The term “loss circulation” and “lost circulation” are used interchangeably to indicate an additive or a fluid that reduces loss of fluids into a formation or a zone within a formation.

The term “gpt” means gallons per thousand gallons.

The term “ppt” means pounds per thousand gallons.

### DETAILED DESCRIPTION OF THE INVENTION

The inventors have found that new lost circulation additives for use in constructing downhole fluids, where the lost circulation additives include a guar chaff material or a mixture of chaff materials, waste materials produced during the production of guar gum. The inventors have also found that drilling fluids including the lost circulation additives including a guar chaff material or a mixture of chaff materials have improved lost circulation properties compared to fluids in the absence of the present lost circulation additives. The inventors have also found that the new lost circulation additives may be adjusted by mixing guar chaffs of different particle sizes to form downhole fluids that are formulated for the type of lost circulation encountered in a formation during drilling.

The oil industry uses many materials and techniques to combat lost circulation. Examples of some of the materials include the use of various kinds of ground up nut shells, fibrous particles, cellophane flakes, ground up mica, calcium carbonate and other materials. The inventors have found that guar chaffs represent a new class of lost circulation additives for use in drilling fluid additives. Testing of a fluids including guar chaff loss control additive confirm the utility of guar chaff materials as effective and tunable lost circulation additives for downhole fluids to control lost circulation.

Sand bed plugging tests indicated that there are viable applications for the guar chaff materials as lost circulation materials for use in downhole applications. Testing also indicates that these guar chaff materials are viable in pill-type lost circulation remediation. Pill-type lost circulation applications would incorporate a mixture of different grades of guar chaff materials in the formulation of a lost circulation pill, where the grades or particle size distribution would be adjusted to the type of loss occurring in the borehole during drilling. Fine particle sized guar chaff material such as guar LVG would add viscosity for the pill. Medium sized guar chaff such as guar CHURL and the coarse sized guar chaff such as Guar KORMA would be blended and added to the viscous pill to provide plugging material with varied particle size distribution. The viscous pill would be pumped and spotted at the lost circulation zone.

Historically, guar chaff from the production of API grade guar gum was used for animal feed, but we have found the such guar chaff materials represent suitable lost circulation additives to prepare novel drilling fluids, lost circulation remediation pills, and other downhole fluids that require improved lost circulation characteristics.

The lost circulation compositions of the present invention include a polymer or polymers, a cross-linking agent or agents, and a lost circulation additive comprising a guar chaff material having a particle size distribution adjusted to the type of lost circulation encountered during drilling.

The fluids of this invention may include differing relative amounts polymers, cross-linking agents, and lost circulation additive of this invention so that the desired lost circulation remediation results are achieved.

Generally, the lost circulation additives of this invention comprise between about 1 wt. % and about 99 wt. % of a guar chaff material having a desired particle size distribution, based on a total weight of the polymers, fibers, and particles in the composition. In certain embodiments, the lost circulation additives of this invention comprise between about 25 wt. % to about 90 wt. % of a guar chaff material having a desired particle size distribution, based on a total weight of the polymers, fibers, and particles in the composition. In other embodiments, the lost circulation additives of this invention comprise between about 50 wt. % and about 80 wt. % of a guar chaff material having a desired particle size distribution, based on a total weight of the polymers, fibers, and particles in the composition. In other embodiments, the lost circulation additives of this invention comprise between about 70 wt. % and about 75 wt. % of a guar chaff material having a desired particle size distribution, based on a total weight of the polymers, fibers, and particles in the composition.

The lost circulation additive compositions of this invention may comprise an effective amount of a crosslinking agent or agents, where the effective amount is sufficient to achieve a desired degree of crosslinking.

The lost circulation additive compositions of this invention may also include amounts of dispersants, retarders, accelerants, other additives or mixtures and combinations thereof to provide desired final compositions properties.

### Methods for Making Compositions

The various components of the present invention may be mixed in any suitable order utilizing mixing techniques as known to those in the art, including dry mixing of the various components prior to addition to water, or alternatively, either or both of the polymer and cross-linking agent may be utilized as a solution. The various components are mixed in dry form, and then contacted with water or aqueous solution to form a lost circulation fluid. This lost circulation fluid is then injected into the well as is known in the art.

### Methods of Using Compositions

### Fracturing

The present invention provides a method for fracturing a formation including the step of pumping a fracturing fluid including a proppant into a producing formation at a pressure sufficient to fracture the formation and to enhance productivity, where the proppant props open the formation after fracturing and where the proppant comprises a particulate solid treated with a treating composition comprising an amine and a phosphate ester under conditions sufficient for the amine and phosphate ester to react forming a partial or complete coating on surfaces of particulate solid material.

The present invention provides a method for fracturing a formation including the step of pumping a fracturing fluid including a proppant and an aggregating composition of this invention into a producing formation at a pressure sufficient to fracture the formation and to enhance productivity. The composition results in a modification of an aggregation propensity, and/or zeta-potential of the proppant, formation particles and formation surfaces so that the formation particles and/or proppant aggregate and/or cling to the formation surfaces.

The present invention provides a method for fracturing a formation including the step of pumping a fracturing fluid including an aggregating composition of this invention into a producing formation at a pressure sufficient to fracture the formation and to enhance productivity. The composition results in a modification of an aggregation propensity, potential and/or zeta-potential of the formation particles and formation surfaces so that the formation particles aggregate and/or cling to the formation surfaces. The method can also include the step of pumping a proppant comprising a coated particulate solid composition of this invention after fracturing so that the coated particles prop open the fracture formation and tend to aggregate to the formation surfaces and/or formation particles formed during fracturing.

### Drilling

The present invention provides a method for drilling including the step of while drilling, circulating a drilling fluid, to provide bit lubrication, heat removal and cutting removal, where the drilling fluid includes an aggregating composition of this invention. The composition increases an aggregation potential or propensity and/or alters a zeta potential of any particulate metal oxide-containing solid in the drilling fluid or that becomes entrained in the drilling fluid to increase solids removal. The method can be operated in over-pressure conditions or under-balanced conditions or under managed pressure conditions. The method is especially well tailored to under-balanced or managed pressure conditions.

The present invention provides a method for drilling including the step of while drilling, circulating a first drilling fluid to provide bit lubrication, heat removal and cutting removal. Upon encountering an underground structure that produces undesirable quantities of particulate solids, changing the first drilling fluid to a second drilling fluid including a composition of this invention to provide bit lubrication, heat removal and cutting removal and to increase an aggregation potential or decrease the absolute value of the zeta potential of any particulate solids in the drilling fluid or that becomes entrained in the drilling fluid to increase solids removal. The method can be operated in over-pressure conditions or under-balanced conditions or under managed pressure conditions. The method is especially well tailored to under-balanced or managed pressure conditions.

The present invention provides a method for drilling including the step of while drilling, circulating a first drilling fluid to provide bit lubrication, heat removal and cutting removal. Upon encountering an underground structure that produces undesirable quantities of particulate solids, changing the first drilling fluid to a second drilling fluid including a composition of this invention to provide bit lubrication, heat removal and cutting removal and to increase an aggregation potential or decrease in the absolute value of the zeta potential of any particulate solids in the drilling fluid or that becomes entrained in the drilling fluid to increase solids removal. After passing through the structure that produces an undesired quantities of particulate solids, change the second drilling fluid to the first drilling fluid or a third drilling fluid. The method can be operated in over-pressure conditions or under-balanced conditions or under managed pressure conditions. The method is especially well tailored to under-balanced or managed pressure conditions.

### Producing

The present invention provides a method for producing including the step of circulating and/or pumping a fluid into a well on production, where the fluid includes a composition of this invention, which increases an aggregation potential or decreases the absolute value of the zeta potential of any particulate solid in the fluid or that becomes entrained in the fluid to increase solid particle removal and to decrease the potential of the particles to plug the formation and/or the production tubing.

The present invention also provides a method for controlling sand or fines migration including the step of pumping a fluid including a composition of this invention through a matrix at a rate and pressure into a formation to control sand and fine production or migration into the production fluids.

The present invention also provide another method for controlling sand or fines migration including the step of depositing a coated particulate solid material of this invention adjacent screen-type sand and fines control devices so that the sand and/or fines are attracted to the coated particles and do not encounter or foul the screen of the screen-type device.

### Suitable Reagents for Use in the Present Invention

### Polymers

Suitable polymers for use in the present invention include, without limitation, a water soluble polymer and must be capable of being pumped as a liquid and subsequently crosslinked in place to form a substantially non-flowing crosslinked polymer, which has sufficient strength to withstand the pressures exerted on it. Moreover, it must have a network structure capable of incorporating guar chaff lost circulation materials.

Exemplary polymers include, without limitation, a carboxylate-containing polymer. Such carboxylate-containing polymers may be any crosslinkable, high molecular weight, water-soluble, synthetic polymers or biopolymers containing one or more carboxylate species.

The average molecular weight of the carboxylate-containing polymers utilized in the practice of the present invention is in the range of about 10,000 and about 50,000,000. In certain embodiments, the average molecular weight range is between about 100,000 and about 20,000,000. In certain embodiments, the average molecular weight range is between about 200,000 and about 15,000,000.

Biopolymers useful in the present invention include polysaccharides and modified polysaccharides. Non-limiting examples of biopolymers include xanthan gum, guar gum, carboxymethylcellulose, o-carboxychitosans, hydroxyethylcellulose, hydroxypropylcellulose, and modified starches. Non-limiting examples of useful synthetic polymers include acrylamide polymers, such as polyacrylamide, partially hydrolyzed polyacrylamide and terpolymers containing acrylamide, acrylate, and a third species. As defined herein, polyacrylamide (PA) is an acrylamide polymer having substantially less than 1% of the acrylamide groups in the form of carboxylate groups. Partially hydrolyzed polyacrylamide (PHPA) is an acrylamide polymer having at least 1%, but not 100%, of the acrylamide groups in the form of carboxylate groups. The acrylamide polymer may be prepared according to any conventional method known in the art. In certain embodiments, the acrylamide polymer has the specific properties of acrylamide polymer prepared according to the method disclosed by U.S. Pat. No. Re. 32,114 to Argabright et al incorporated herein by reference.

### Crosslinking Agents

Any crosslinking agent suitable for use with the selected polymer may be utilized in the practice of the present invention. In certain embodiments, the crosslinking agent utilized in the present invention is a chromic carboxylate complex. In other embodiment, the crosslinking agents include borate crosslinking agents such as borax. In other embodiments, the crosslinking agents include, without limitation, any divalent, trivalent or polyvalent metals ions salts capable of crosslinking the polymers of this invention.

The term “complex” is defined herein as an ion or molecule containing two or more interassociated ionic, radical or molecular species. A complex ion as a whole has a distinct electrical charge while a complex molecule is electrically neutral. The term “chromic carboxylate complex” encompasses a single complex, mixtures of complexes containing the same carboxylate species, and mixtures of complexes containing differing carboxylate species.

The chromic carboxylate complex useful in the practice of the present invention includes at least one or more electropositive chromium III species and one or more electronegative carboxylate species. The complex may advantageously also contain one or more electronegative hydroxide and/or oxygen species. It is believed that, when two or more chromium III species are present in the complex, the oxygen or hydroxide species may help to bridge the chromium III species. Each complex optionally contains additional species which are not essential to the polymer crosslinking function of the complex. For example, inorganic mono- and/or divalent ions, which function merely to balance the electrical charge of the complex, or one or more water molecules may be associated with each complex. Non-limiting representative formulae of such complexes include: [Cr₃(CH₃CO₂)₆(OH)₂]¹⁺; [Cr₃(CH₃CO₂)₆(OH)₂]NO₃.6H₂O; [Cr₃(CH₃CO₂)₆(OH)₂]³⁺; and [CT₃(CH₃CO₂)₆(OH)₂](CH₃CO₂)₃.H₂O.

“Trivalent chromium” and “chromic ion” are equivalent terms encompassed by the term “chromium III” species as used herein.

The carboxylate species are advantageously derived from water-soluble salts of carboxylic acids, especially low molecular weight mono-basic acids. Carboxylate species derived from salts of formic, acetic, propionic, and lactic acid, substituted derivatives thereof and mixtures thereof are preferred. In certain embodiments, the carboxylate species include the following water-soluble species: formate, acetate, propionate, lactate, substituted derivatives thereof, and mixtures thereof. Acetate is the most preferred carboxylate species. Examples of optional inorganic ions include sodium, sulfate, nitrate and chloride ions.

Salts of chromium and an inorganic monovalent anion, e.g., CrCl₃, may also be combined with the crosslinking agent complex to accelerate gelation of the polymer solution, as described in U.S. Pat. No. 4,723,605 to Sydansk, which is incorporated herein by reference.

The molar ratio of carboxylate species to chromium III in the chromic carboxylate complexes used in the process of the present invention is typically in the range of 1:1 to 3.9:1. In certain embodiments, the ratio is in range of 2:1 to 3.9:1. In other embodiments, the ratio is 2.5:1 to 3.5:1.

The additive of the present invention may comprise fibers or comminuted particles of plant materials, and preferably comprises comminuted particles of one or more plant materials.

### Guar Chaff Materials

Guar chaff materials include, without limitation, any guar chaff material or waste or by-product material obtained from the manufacture of guar gum or other gum materials. Exemplary examples of guar chaff materials include, without limitation, fine guar chaff materials, medium guar chaff materials, coarse guar chaff materials, or mixtures and combinations thereof. Specific chaff materials include fine guar chaff materials such as Guar LUG (fine), medium guar chaff materials such as Guar CHURL (medium), and coarse guar chaff materials such as Guar KORMA (coarse), all three available from Sunita Hydrocolliods Private Limited. While several examples of guar chaff materials are disclosed, any other guar chaff materials may be used as well as galactomannan containing materials.

Optionally, dispersant for the guar chaff materials may be utilized in the range of about 1 to about 20 pounds. In certain embodiments, the range is between about 5 and about 10 pounds. In other embodiments, the range is between about 7 and about 8 pounds of dispersant may be utilized per pound of comminuted plant material.

Any suitable size of comminuted material may be utilized in the present invention, as long as such size produces results which are desired. In most instances, the size range of the guar chaff materials utilized herein will range from below about 8 mesh (“mesh” as used herein refers to standard U.S. mesh), preferably from about 65 mesh to about 100 mesh, and more preferably from about 65 mesh to about 85 mesh. Specifically preferred particle sizes for some materials are provided below.

### Fine Guar Chaff Materials

Fine guar chaff materials comprise guar chaff materials having a mono modal particle size distribution. In certain embodiments, the mono modal particle size distribution includes particles between about 0.1 μm and about 500 μm. In other embodiments, the mono modal particle size distribution includes particles between about 0.1 μm and about 400 μm. In other embodiments, the mono modal particle size distribution includes particles between about 0.1 μm and about 300 μm. In other embodiments, the mono modal particle size distribution includes particles between about 0.5 μm and about 500 μm. In other embodiments, the mono modal particle size distribution includes particles between about 0.5 μm and about 400 μm. In other embodiments, the mono modal particle size distribution includes particles between about 0.5 μm and about 300 μm. In other embodiments, the mono modal particle size distribution includes particles between about 1 μm and about 500 μm. In other embodiments, the mono modal particle size distribution includes particles between about 1 μm and about 400 μm. In other embodiments, the mono modal particle size distribution includes particles between about 1 μm and about 300 μm.

In other embodiments, the fine guar chaff material has a poly modal particle size distribution. In certain embodiments, the poly modal particle size distribution includes from about 1 wt. % to about 10 wt. % of particles between about 0.1 μm and about 1 μm and from about 99 wt. % and 90 wt. % of particles between about 1 μm and about 500 μm. In other embodiments, the poly modal particle size distribution includes from about 1 wt. % to about 5 wt. % of particles between about 0.1 μm and about 1 μm and from about 99 wt. % and 95 wt. % of particles between about 1 μm and about 500 μm. In other embodiments, the poly modal particle size distribution includes from about 1 wt. % to about 2.5 wt. % of particles between about 0.1 μm and about 1 μm and from about 99 wt. % and 97.5 wt. % of particles between about 1 μm and about 500 μm.

### Medium Guar Chaff Materials

Medium guar chaff materials comprise guar chaff materials having a mono modal particle size distribution. In certain embodiments, the mono modal particle size distribution includes particles between about 1 μm and about 700 μm. In other embodiment, the mono modal particle size distribution includes particles between about 1 μm and about 600 μm. In other embodiments, the mono modal particle size distribution includes particles between about 1 μm and about 500 μm. In other embodiments, the mono modal particle size distribution includes particles between about 5 μm and about 700 μm. In other embodiments, the mono modal particle size distribution includes particles between about 5 μm and about 600 μm. In other embodiments, the mono modal particle size distribution includes particles between about 5 μm and about 500 μm. In other embodiments, the mono modal particle size distribution includes particles between about 10 μm and about 700 μm. In other embodiments, the mono modal particle size distribution includes particles between about 10 μm and about 600 μm. In other embodiments, the mono modal particle size distribution includes particles between about 10 μm and about 500 μm.

In other embodiments, the medium guar chaff material has poly modal particle size distribution. In certain embodiments, the poly modal particle size distribution includes from about 30 wt. % to about 70 wt. % of particles between about 1 μm and about 200 μm and from about 70 wt. % and 30 wt. % of particles between about 30 μm and about 700 μm. In other embodiments, the poly modal particle size distribution includes from about 40 wt. % to about 60 wt. % of particles between about 1 μm and about 200 μm and from about 60 wt. % and 40 wt. % of particles between about 30 μm and about 700 μm. In other embodiments, the poly modal particle size distribution includes from about 50 wt. % of particles between about 1 μm and about 200 μm and from about 50 wt. % of particles between about 30 μm and about 700 μm. In certain embodiments, the poly modal particle size distribution includes from about 1 wt. % to about 10 wt. % of particles between about 0.1 μm and about 1 μm, from about 1 wt. % to about 10 wt. % of particles between about 1 μm and about 200 μm, and from about 69 wt. % and 25 wt. % of particles between about 30 μm and about 700 μm. In other embodiments, the poly modal particle size distribution includes from about 1 wt. % to about 5 wt. % of particles between about 0.1 μm and about 1 μm, from about 30 wt. % to about 67.5 wt. % of particles between about 1 μm and about 200 μm, and from about 69 wt. % and 27.5 wt. % of particles between about 30 μm and about 700 μm. In other embodiments, the poly modal particle size distribution includes from about 1 wt. % to about 2.5 wt. % of particles between about 0.1 μm and about 1 μm, from about 30 wt. % to about 68.75 wt. % of particles between about 1 μm and about 200 μm, and from about 69 wt. % and 28.75 wt. % of particles between about 30 μm and about 700 μm.

### Coarse Guar Chaff Materials

Coarse guar chaff materials comprise guar chaff materials having a mono modal particle size distribution. In certain embodiments, the mono modal particle size distribution includes particles between about 100 μm and about 3000 μm. In other embodiments, the mono modal particle size distribution includes particles between about 100 μm and about 2000 μm. In other embodiments, the mono modal particle size distribution includes particles between about 100 μm and about 1000 μm. In other embodiments, the mono modal particle size distribution includes particles between about 200 μm and about 3000 μm. In other embodiments, the mono modal particle size distribution includes particles between about 200 μm and about 2000 μm. In other embodiments, the mono modal particle size distribution includes particles between about 200 μm and about 1000 μm. In other embodiments, the mono modal particle size distribution includes particles between about 300 μm and about 3000 μm. In other embodiments, the mono modal particle size distribution includes particles between about 300 μm and about 2000 μm. In other embodiments, the mono modal particle size distribution includes particles between about 300 μm and about 1000 μm.

In other embodiments, the coarse guar chaff material has poly modal particle size distribution. In certain embodiments, the poly modal particle size distribution includes from about 1 wt. % to about 20 wt. % of particles between about 300 μm and about 600 μm and from about 99 wt. % and 80 wt. % of particles between about 400 μm and about 2000 μm. In other embodiments, the poly modal particle size distribution includes from about 1 wt. % to about 15 wt. % of particles between about 300 μm and about 600 μm and from about 99 wt. % and 85 wt. % of particles between about 400 μm and about 2000 μm. In other embodiments, the poly modal particle size distribution includes from about 1 wt. % to about 10 wt. % of particles between about 300 μm and about 600 μm and from about 99 wt. % and 90 wt. % of particles between about 400 μm and about 2000 μm.

### Water Bases

Suitable aqueous solutions for use in the preparation of water-based downhole fluids include, without limitation, fresh water, salt water, brines, or other aqueous solutions including other additives.

### Oil Bases

Suitable base oils include, without limitation, paraffins oils, naphthenic oil, aliphatic solvents and/or oils, aromatic oils, or mixtures and combinations thereof. Exemplary base oils include CALPRINT® 38LP, HYDROCAL® 38, and CONOSOL® C-145 available from Calumet Specialty Products Partners, L.P. of Indianapolis, Ind., RENOIL® 30 available from Renkert Oil of Morgantown, Pa. and BIOBASE® 360 available from Shrieve Chemical Products, Inc., The Woodlands, Tex.

### Surfactants for Inverted Fluids

Suitable primary emulsifiers for use in the formulations of this invention include, without limitation, any primary emulsifying agents used in forming inverted emulsion compositions and muds for use in oil field application. Exemplary examples of primary emulsifiers include, without limitation, fatty acid salts, amidoamine fatty acid salts, and mixtures or combinations thereof. Other suitable primary emulsifier can be found in U.S. Pat. Nos. 4,012,329; 4,108,779; 5,508,258; 5,559,085; 6,608,006; 7,125,826; 7,285,515; and 7,449,846, as set forth in the last paragraph of this application, these references are incorporated by reference in conformity to United States Laws, Rules and Regulations. These references also disclose other secondary emulsifiers that can be used in combination with the new secondary emulsifiers of this invention.

### Aromatic Compounds

Suitable aromatic compounds include, without limitation, phenol, substituted phenols, hydroxylated naphthalenes, substituted hydroxylated naphthalenes, hydroxylated anthracenes, substituted hydroxylated anthracenes, hydroxylated phenanthrenes, substituted hydroxylated phenanthrenes, hydroxylated chrysenes, substituted hydroxylated chrysenes, hydroxylated pyrenes, substituted hydroxylated pyrenes, hydroxylated corannulenes, substituted hydroxylated corannulenes, hydroxylated coronenes, substituted hydroxylated coronenes, hydroxylated hexahelicenes, substituted hydroxylated hexahelicenes, hetero analogs, where the hetero atom is B, N, O, Si, P, or S and the substituents can be halogen atoms, carbyl groups (R), alkoxy groups (OR), amino (NRR′), amido groups (CONHR), sulfide groups (SR), silyl groups (SiRR′R″), or the like, and where the hydroxy group is capable of being esterified and mixtures or combinations thereof.

### Acids

Suitable acid, acid chlorides or anhydrides for use in making the secondary emulsifiers of this invention include, without limitation, myristoleic acid palmitoleic acid, oleic acid, linoleic acid, α-linolenic acid, arachidonic acid, eicosapentaenoic acid, erucic acid, docosahexaenoic acid, capric acid or decanoic acid, undecanoic acid, lauric acid or dodecanoic acid, tridecanoic acid, myristic acid or tetradecanoic acid, palmitic acid or hexadecanoic acid, stearic acid or octadecanoic acid, and arachidic acid or eicosanoic acid, their anhydrides and their acid chlorides, and mixtures or combinations thereof.

### Cationic Polymers

Suitable cationic polymers include polyamines, quaternary derivatives of cellulose ethers, quaternary derivatives of guar, homopolymers and copolymers of at least 20 mole percent dimethyl diallyl ammonium chloride (DMDAAC), homopolymers and copolymers of methacrylamidopropyl trimethyl ammonium chloride (MAPTAC), homopolymers and copolymers of acrylamidopropyl trimethyl ammonium chloride (APTAC), homopolymers and copolymers of methacryloyloxyethyl trimethyl ammonium chloride (METAC), homopolymers and copolymers of acryloyloxyethyl trimethyl ammonium chloride (AETAC), homopolymers and copolymers of methacryloyloxyethyl trimethyl ammonium methyl sulfate (METAMS), and quaternary derivatives of starch and mixtures or combinations thereof.

### Anionic Polymers

Suitable anionic polymers include homopolymers and copolymers of acrylic acid (AA), homopolymers and copolymers of methacrylic acid (MAA), homopolymers and copolymers of 2-acrylamido-2-methylpropane sulfonic acid (AMPSA), homopolymers and copolymers of N-methacrylamidopropyl N,N-dimethyl amino acetic acid, N-acrylamidopropyl N,N-dimethyl amino acetic acid, N-methacryloyloxyethyl N,N-dimethyl amino acetic acid, and N-acryloyloxyethyl N,N-dimethyl amino acetic acid and mixtures or combinations thereof.

### Anionic Surfactants

Anionic surfactants suitable for use with the cationic polymers include alkyl, aryl or alkyl aryl sulfates, alkyl, aryl or alkyl aryl carboxylates or alkyl, aryl or alkyl aryl sulfonates. In certain embodiments, the alkyl moieties have about 1 to about 18 carbons, the aryl moieties have about 6 to about 12 carbons, and the alkyl aryl moieties have about 7 to about 30 carbons. Exemplary groups are propyl, butyl, hexyl, decyl, dodecyl, phenyl, benzyl and linear or branched alkyl benzene derivatives of the carboxylates, sulfates and sulfonates. Included are alkyl ether sulphates, alkaryl sulphonates, alkyl succinates, alkyl sulphosuccinates, N-alkoyl sarcosinates, alkyl phosphates, alkyl ether phosphates, alkyl ether carboxylates, alpha-olefin sulphonates and acyl methyl taurates, especially their sodium, magnesium ammonium and mono-, di- and triethanolamine salts or mixtures or combinations thereof. The alkyl and acyl groups generally contain from 8 to 18 carbon atoms and may be unsaturated. The alkyl ether sulphates, alkyl ether phosphates and alkyl ether carboxylates may contain from one to 10 ethylene oxide or propylene oxide units per molecule. In certain embodiments, the alkyl ether sulphates, alkyl ether phosphates and alkyl ether carboxylates contain 2 to 3 ethylene oxide units per molecule. Examples of suitable anionic surfactants include ammonium lauryl sulphate, ammonium lauryl ether sulphate, ammonium lauryl sulphosuccinate, ammonium lauryl sulphate, ammonium lauryl ether sulphate, sodium dodecylbenzene sulphonate, triethanolamine dodecylbenzene sulphonate, triethanolamin dodecyl sulfate, ammonium cocoyl isethionate, ammonium lauroyl isethionate, and ammonium N-lauryl sarcosinate and mixtures or combinations thereof. In other embodiments, some of the anionic surfactants can be sodium, potassium, cesium or other similar anionic surfactants or mixtures of these alkali metal surfactants with ammonium surfactants.

### Cationic Surfactants

Cationic surfactants suitable for use with the anionic polymers include quaternary ammonium surfactants of the formula X⁻N⁺R¹R²R³ where R¹, R², and R³ are independently selected from hydrogen, an aliphatic group of from about 1 to about 22 carbon atoms, or aromatic, aryl, an alkoxy, polyoxyalkylene, alkylamido, hydroxyalkyl, or alkylaryl group having from about 1 to about 22 carbon atoms; and X is an anion selected from halogen, acetate, phosphate, nitrate, sulfate, alkylsulfate radicals (e.g., methyl sulfate and ethyl sulfate), tosylate, lactate, citrate, and glycolate and mixtures or combinations thereof. The aliphatic groups may contain hydroxy groups, in addition to carbon and hydrogen atoms, ether linkages, and other groups such hydroxyl or amino group substituents (e.g., the alkyl groups can contain polyethylene glycol and polypropylene glycol moieties). The longer chain aliphatic groups, e.g., those of about 12 carbons, or higher, can be saturated or unsaturated. In other embodiments, R¹ is an alkyl group having from about 12 to about 18 carbon atoms; R² is selected from H or an alkyl group having from about 1 to about 18 carbon atoms; R³ and R⁴ are independently selected from H or an alkyl group having from about 1 to about 3 carbon atoms; and X is as described above.

### Lower Alcohols

Suitable lower alcohols for use in the present invention include, without limitation, alcohols of the general formula ROH, where R is a linear or branched carbyl group having between 1 and 5 carbon atoms, where one or more carbons atoms can be replaced with an oxygen, nitrogen, or sulfur atom, and one or more of the hydrogen atoms can be replaced with a halogen atom, an alkoxy group, a amide group or any other group that can replace a hydrogen atom and does not adversely affect the properties of the alcohol. In certain embodiment, the of the general formula C₁H₂ₙ₊₂OH, where m is an integer having a value between about 1 and about 5. In certain embodiment, n is an integer having a value between 2 and 4. In other embodiment, n is an integer having a value between 3 and 4. In other embodiment, n is an integer having a value of 3.

### Gel Promoters

By a gel promoter we mean a betaine, a sultaine or hydroxysultaine, or an amine oxide.

Examples of betaines include the higher alkyl betaines such as coco dimethyl carboxymethyl betaine, lauryl dimethyl carboxymethyl betaine, lauryl dimethyl alphacarboxyethyl betaine, cetyl dimethyl carboxymethyl betaine, cetyl dimethyl betaine, lauryl bis-(2-hydroxyethyl) carboxymethyl betaine, oleyl dimethyl gamma-carboxypropyl betaine, lauryl bis-(2-hydroxypropyl)alpha-carboxyethyl betaine, coco dimethyl sulfopropyl betaine, lauryl dimethyl sulfoethyl betaine, lauryl bis-(2-hydroxyethyl) sulfopropyl betaine, amidobetaines and amidosulfobetaines (wherein the RCONH(CH₂)₃ radical is attached to the nitrogen atom of the betaine, oleyl betaine, and cocamidopropyl betaine and mixtures or combinations thereof. Examples of sultaines and hydroxysultaines include materials such as cocamidopropyl hydroxysultaine.

### Amphoteric Surfactants

Amphoteric surfactants suitable for use with either cationic polymers or anionic polymers include those surfactants broadly described as derivatives of aliphatic secondary and tertiary amines in which the aliphatic radical can be straight or branched chain and wherein one of the aliphatic substituents contains from about 8 to about 18 carbon atoms and one contains an anionic water solubilizing group such as carboxy, sulfonate, sulfate, phosphate, or phosphonate and mixtures or combinations thereof. Suitable amphoteric surfactants include derivatives of aliphatic secondary and tertiary amines in which the aliphatic radical can be straight or branched chain and wherein one of the aliphatic aliphatic substituents contains from about 8 to about 18 carbon atoms and one contains an anionic water solubilizing group, e.g., carboxy, sulfonate, sulfate, phosphate, or phosphonate and mixtures or combinations thereof. Examples of compounds falling within this definition are sodium 3-dodecylaminopropionate, and sodium 3-dodecylaminopropane sulfonate and mixtures or combinations thereof.

### Amine Oxide

Suitable amine oxides include, without limitation, cocoamidopropyl dimethyl amine oxide and other compounds of the formula R¹R²R³N→O wherein R³ is a hydrocarbyl or substituted hydrocarbyl having from about 8 to about 30 carbon atoms, and R¹ and R² are independently hydrogen, a hydrocarbyl or substituted hydrocarbyl having up to 30 carbon atoms and mixtures or combinations thereof. In other embodiments, R³ is an aliphatic or substituted aliphatic hydrocarbyl having at least about 12 and up to about 24 carbon atoms and mixtures or combinations thereof. In other embodiments, R³ is an aliphatic group having at least about 12 carbon atoms and having up to about 22 and mixtures or combinations thereof. In other embodiments, an aliphatic group having at least about 18 and no more than about 22 carbon atoms and mixtures or combinations thereof.

### Gases

Suitable gases for foaming the foamable, ionically coupled gel composition include, without limitation, nitrogen, carbon dioxide, natural gas, other hydrocarbon gases, or any other gas suitable for use in formation fracturing, or mixtures or combinations thereof.

### Liquid Gases

Suitable liquid gases for gelling include, without limitation, liquid carbon dioxide, liquid nitrogen, liquid natural gas, other liquified gases, or mixtures and combinations thereof.

### Proppants and Solid Materials

Suitable solid materials suitable for being used as a proppant or solid additive in the compositions of this invention include, without limitation, metal oxides and/or ceramics, natural or synthetic, metals, plastics and/or other polymeric solids, solid materials derived from plants, or any other solid material that does or may find use in downhole applications or mixtures or combinations thereof. Metal oxides including any solid oxide of a metallic element of the periodic table of elements. Exemplary examples of metal oxides and ceramics include actinium oxides, aluminum oxides, antimony oxides, boron oxides, barium oxides, bismuth oxides, calcium oxides, cerium oxides, cobalt oxides, chromium oxides, cesium oxides, copper oxides, dysprosium oxides, erbium oxides, europium oxides, gallium oxides, germanium oxides, iridium oxides, iron oxides, lanthanum oxides, lithium oxides, magnesium oxides, manganese oxides, molybdenum oxides, niobium oxides, neodymium oxides, nickel oxides, osmium oxides, palladium oxides, potassium oxides, promethium oxides, praseodymium oxides, platinum oxides, rubidium oxides, rhenium oxides, rhodium oxides, ruthenium oxides, scandium oxides, selenium oxides, silicon oxides, samarium oxides, silver oxides, sodium oxides, strontium oxides, tantalum oxides, terbium oxides, tellurium oxides, thorium oxides, tin oxides, titanium oxides, thallium oxides, thulium oxides, vanadium oxides, tungsten oxides, yttrium oxides, ytterbium oxides, zinc oxides, zirconium oxides, ceramic structures prepared from one or more of these oxides and mixed metal oxides including two or more of the above listed metal oxides. Exemplary examples of plant materials include, without limitation, shells of seed bearing plants such as walnut shells, pecan shells, peanut shells, shells for other hard shelled seed forming plants, ground wood or other fibrous cellulosic materials, or mixtures or combinations thereof.

### Scale Control

Suitable additives for Scale Control and useful in the compositions of this invention include, without limitation: Chelating agents, e.g., Na, K or NH₄⁺ salts of EDTA; Na, K or NH₄⁺ salts of NTA; Na, K or NH₄⁺ salts of Erythorbic acid; Na, K or NH₄⁺ salts of thioglycolic acid (TGA); Na, K or NH₄⁺ salts of Hydroxy acetic acid; Na, K or NH₄⁺ salts of Citric acid; Na, K or NH₄⁺ salts of Tartaric acid or other similar salts or mixtures or combinations thereof. Suitable additives that work on threshold effects, sequestrants, include, without limitation: Phosphates, e.g., sodium hexamethylphosphate, linear phosphate salts, salts of polyphosphoric acid, Phosphonates, e.g., nonionic such as HEDP (hydroxythylidene diphosphoric acid), PBTC (phosphoisobutane, tricarboxylic acid), Amino phosphonates of: MEA (monoethanolamine), NH₃, EDA (ethylene diamine), Bishydroxyethylene diamine, Bisaminoethylether, DETA (diethylenetriamine), HMDA (hexamethylene diamine), Hyper homologues and isomers of HMDA, Polyamines of EDA and DETA, Diglycolamine and homologues, or similar polyamines or mixtures or combinations thereof; Phosphate esters, e.g., polyphosphoric acid esters or phosphorus pentoxide (P₂O₅) esters of: alkanol amines such as MEA, DEA, triethanol amine (TEA), Bishydroxyethylethylene diamine; ethoxylated alcohols, glycerin, glycols such as EG (ethylene glycol), propylene glycol, butylene glycol, hexylene glycol, trimethylol propane, pentaeryithrol, neopentyl glycol or the like; Tris & Tetra hydroxy amines; ethoxylated alkyl phenols (limited use due to toxicity problems), Ethoxylated amines such as monoamines such as MDEA and higher amines from 2 to 24 carbons atoms, diamines 2 to 24 carbons carbon atoms, or the like; Polymers, e.g., homopolymers of aspartic acid, soluble homopolymers of acrylic acid, copolymers of acrylic acid and methacrylic acid, terpolymers of acylates, AMPS, etc., hydrolyzed polyacrylamides, poly malic anhydride (PMA); or the like; or mixtures or combinations thereof.

### Corrosion Inhibitors

Suitable additives for Corrosion Inhibition and for use in the compositions of this invention include, without limitation: quaternary ammonium salts e.g., chloride, bromides, iodides, dimethylsulfates, diethylsulfates, nitrites, hydroxides, alkoxides, or the like, or mixtures or combinations thereof; salts of nitrogen bases; or mixtures or combinations thereof. Exemplary quaternary ammonium salts include, without limitation, quaternary ammonium salts from an amine and a quaternarization agent, e.g., alkylchlorides, alkylbromide, alkyl iodides, alkyl sulfates such as dimethyl sulfate, diethyl sulfate, etc., dihalogenated alkanes such as dichloroethane, dichloropropane, dichloroethyl ether, epichlorohydrin adducts of alcohols, ethoxylates, or the like; or mixtures or combinations thereof and an amine agent, e.g., alkylpyridines, especially, highly alkylated alkylpyridines, alkyl quinolines, C6 to C24 synthetic tertiary amines, amines derived from natural products such as coconuts, or the like, dialkylsubstituted methyl amines, amines derived from the reaction of fatty acids or oils and polyamines, amidoimidazolines of DETA and fatty acids, imidazolines of ethylenediamine, imidazolines of diaminocyclohexane, imidazolines of aminoethylethylenediamine, pyrimidine of propane diamine and alkylated propene diamine, oxyalkylated mono and polyamines sufficient to convert all labile hydrogen atoms in the amines to oxygen containing groups, or the like or mixtures or combinations thereof. Exemplary examples of salts of nitrogen bases, include, without limitation, salts of nitrogen bases derived from a salt, e.g.: C1 to C8 monocarboxylic acids such as formic acid, acetic acid, propanoic acid, butanoic acid, pentanoic acid, hexanoic acid, heptanoic acid, octanoic acid, 2-ethylhexanoic acid, or the like; C2 to C12 dicarboxylic acids, C2 to C12 unsaturated carboxylic acids and anhydrides, or the like; polyacids such as diglycolic acid, aspartic acid, citric acid, or the like; hydroxy acids such as lactic acid, itaconic acid, or the like; aryl and hydroxy aryl acids; naturally or synthetic amino acids; thioacids such as thioglycolic acid (TGA); free acid forms of phosphoric acid derivatives of glycol, ethoxylates, ethoxylated amine, or the like, and aminosulfonic acids; or mixtures or combinations thereof and an amine, e.g.: high molecular weight fatty acid amines such as cocoamine, tallow amines, or the like; oxyalkylated fatty acid amines; high molecular weight fatty acid polyamines (di, tri, tetra, or higher); oxyalkylated fatty acid polyamines; amino amides such as reaction products of carboxylic acid with polyamines where the equivalents of carboxylic acid is less than the equivalents of reactive amines and oxyalkylated derivatives thereof; fatty acid pyrimidines; monoimidazolines of EDA, DETA or higher ethylene amines, hexamethylene diamine (HMDA), tetramethylenediamine (TMDA), and higher analogs thereof; bisimidazolines, imidazolines of mono and polyorganic acids; oxazolines derived from monoethanol amine and fatty acids or oils, fatty acid ether amines, mono and bis amides of aminoethylpiperazine; GAA and TGA salts of the reaction products of crude tall oil or distilled tall oil with diethylene triamine; GAA and TGA salts of reaction products of dimer acids with mixtures of poly amines such as TMDA, HMDA and 1,2-diaminocyclohexane; TGA salt of imidazoline derived from DETA with tall oil fatty acids or soy bean oil, canola oil, or the like; or mixtures or combinations thereof.

### Biocides

Suitable biocides include, without limitation, Bio-Clear™ 50 (5% active liquid brominated propionamide, DBNPA), Bio-Clear™ 200 (20% active liquid brominated propionamide, DBNPA), Bio-Clear™ 750 (98% active admixture, which combines dry brominated propionamide (DBNPA) and dry brominated glutaronitrile (BBMG)), and Bio-Clear™ 1,000 (concentrated powder form of DBNPA), available from Weatherford, Spectrum® is a chlorine-free antimicrobial agent, Blitz™ is a peracetic acid-based antimicrobial agent, Clarity® is a single component 15% peracetic acid microbial agent, VigorOx® 15 F&V is a peracetic acid-based, chlorine-free microbial control agent, VigorOx® Citrus is a peracetic acid-based anti-microbial, VigorOx® WWT II, a peracetic acid (PAA)-based formulation, is an equilibrium mixture ofperacetic acid, acetic acid, hydrogen peroxide and water, VigorOx® Oil & Gas is a peracetic acid-based biocide, VigorOx® SP-15 is a formulated peracetic acid-based solution, VigorOx® LS-15 is an EPA-registered single component peracetic acid-based microbial agent, VigorOx® LS&D is a peracetic acid-based, chlorine-free EPA approved biocide, PerLoxi Plus, BIOPER, OxyPure® BIO is a highly efficient, peracetic acid-based biocide, peracetic acid available PeroxyChem, WellReady Biocides available from Zinkan, AQUCAR biocides from Dow Chemical Company, other biocides suitable for use downhole, or mixtures and combinations thereof.

### Carbon Dioxide Neutralization

Suitable additives for CO₂ neutralization and for use in the compositions of this invention include, without limitation, MEA, DEA, isopropylamine, cyclohexylamine, morpholine, diamines, dimethylaminopropylamine (DMAPA), ethylene diamine, methoxy proplyamine (MOPA), dimethylethanol amine, methyldiethanolamine (MDEA) & oligomers, imidazolines of EDA and homologues and higher adducts, imidazolines of amino ethylethanolamine (AEEA), aminoethylpiperazine, aminoethylethanol amine, di-isopropanol amine, DOW AMP-90™, Angus AMP-95, dialkylamines (of methyl, ethyl, isopropyl), mono alkylamines (methyl, ethyl, isopropyl), trialkyl amines (methyl, ethyl, isopropyl), bishydroxyethylethylene diamine (THEED), or the like or mixtures or combinations thereof.

### Paraffin Control

Suitable additives for Paraffin Removal, Dispersion, and/or paraffin Crystal Distribution include, without limitation: Cellosolves available from DOW Chemicals Company; Cellosolve acetates; Ketones; Acetate and Formate salts and esters; surfactants composed of ethoxylated or propoxylated alcohols, alkyl phenols, and/or amines; methylesters such as coconate, laurate, soyate or other naturally occurring methylesters of fatty acids; sulfonated methylesters such as sulfonated coconate, sulfonated laurate, sulfonated soyate or other sulfonated naturally occurring methylesters of fatty acids; low molecular weight quaternary ammonium chlorides of coconut oils soy oils or C10 to C24 amines or monohalogenated alkyl and aryl chlorides; quanternary ammonium salts composed of disubstituted (e.g., dicoco, etc.) and lower molecular weight halogenated alkyl and/or aryl chlorides; gemini quaternary salts of dialkyl (methyl, ethyl, propyl, mixed, etc.) tertiary amines and dihalogenated ethanes, propanes, etc. or dihalogenated ethers such as dichloroethyl ether (DCEE), or the like; gemini quaternary salts of alkyl amines or amidopropyl amines, such as cocoamidopropyldimethyl, bis quaternary ammonium salts of DCEE; or mixtures or combinations thereof. Suitable alcohols used in preparation of the surfactants include, without limitation, linear or branched alcohols, specially mixtures of alcohols reacted with ethylene oxide, propylene oxide or higher alkyleneoxide, where the resulting surfactants have a range of HLBs. Suitable alkylphenols used in preparation of the surfactants include, without limitation, nonylphenol, decylphenol, dodecylphenol or other alkylphenols where the alkyl group has between about 4 and about 30 carbon atoms. Suitable amines used in preparation of the surfactants include, without limitation, ethylene diamine (EDA), diethylenetriamine (DETA), or other polyamines. Exemplary examples include Quadrols, Tetrols, Pentrols available from BASF. Suitable alkanolamines include, without limitation, monoethanolamine (MEA), diethanolamine (DEA), reactions products of MEA and/or DEA with coconut oils and acids.

### Oxygen Control

The introduction of water downhole often is accompanied by an increase in the oxygen content of downhole fluids due to oxygen dissolved in the introduced water. Thus, the materials introduced downhole must work in oxygen environments or must work sufficiently well until the oxygen content has been depleted by natural reactions. For system that cannot tolerate oxygen, then oxygen must be removed or controlled in any material introduced downhole. The problem is exacerbated during the winter when the injected materials include winterizers such as water, alcohols, glycols, Cellosolves, formates, acetates, or the like and because oxygen solubility is higher to a range of about 14-15 ppm in very cold water. Oxygen can also increase corrosion and scaling. In CCT (capillary coiled tubing) applications using dilute solutions, the injected solutions result in injecting an oxidizing environment (O₂) into a reducing environment (CO₂, H₂S, organic acids, etc.).

Options for controlling oxygen content includes: (1) de-aeration of the fluid prior to downhole injection, (2) addition of normal sulfides to product sulfur oxides, but such sulfur oxides can accelerate acid attack on metal surfaces, (3) addition of erythorbates, ascorbates, diethylhydroxyamine or other oxygen reactive compounds that are added to the fluid prior to downhole injection; and (4) addition of corrosion inhibitors or metal passivation agents such as potassium (alkali) salts of esters of glycols, polyhydric alcohol ethyloxylates or other similar corrosion inhibitors. Exemplary examples oxygen and corrosion inhibiting agents include mixtures of tetramethylene diamines, hexamethylene diamines, 1,2-diaminecyclohexane, amine heads, or reaction products of such amines with partial molar equivalents of aldehydes. Other oxygen control agents include salicylic and benzoic amides of polyamines, used especially in alkaline conditions, short chain acetylene diols or similar compounds, phosphate esters, borate glycerols, urea and thiourea salts of bisoxalidines or other compound that either absorb oxygen, react with oxygen or otherwise reduce or eliminate oxygen.

### Sulfur Scavenging Agents

The winterized compositions of this invention can also include sulfur scavenging agents provided they are compatible with the compositions. Such sulfur scavenging agents can include those available from Weatherford International, BJ Services, Baker Hughes, Halliburton, other services providers and sulfur scavenger providers. Exemplary examples include those disclosed in United States Pat., Pub. or Appln. Nos. 2007-0032693; U.S. Pat. No. 7,140,433; 2005-0137114; U.S. Pat. No. 7,517,447; Ser. No. 12/419,418; 2005-0250666; U.S. Pat. No. 7,268,100; 2008-0039345; 2006-0194700; 2007-0173414; 2007-0129257; U.S. Pat. No. 7,392,847; 2008-0257553; U.S. Pat. No. 7,350,579; Ser. No. 12/075,461; 2007-0173413; 2008-0099207; 2008-0318812; 2008-0287325; 2008-0257556; 2008-0314124; 2008-0269082; 2008-0197085; 2008-0257554; Ser. No. 12/416,984; 2008-0251252; Ser. Nos. 11/956,433; 12/029,335; 12/237,130; 12/167,087; 12/176,872; 2009-0067931; 2008-0283242; Ser. Nos. 12/240,987; 12/271,580; 12/364,154; 12/357,556; 12/464,351; or 12/465,437.

### EXPERIMENTS OF THE INVENTION

### Example 1

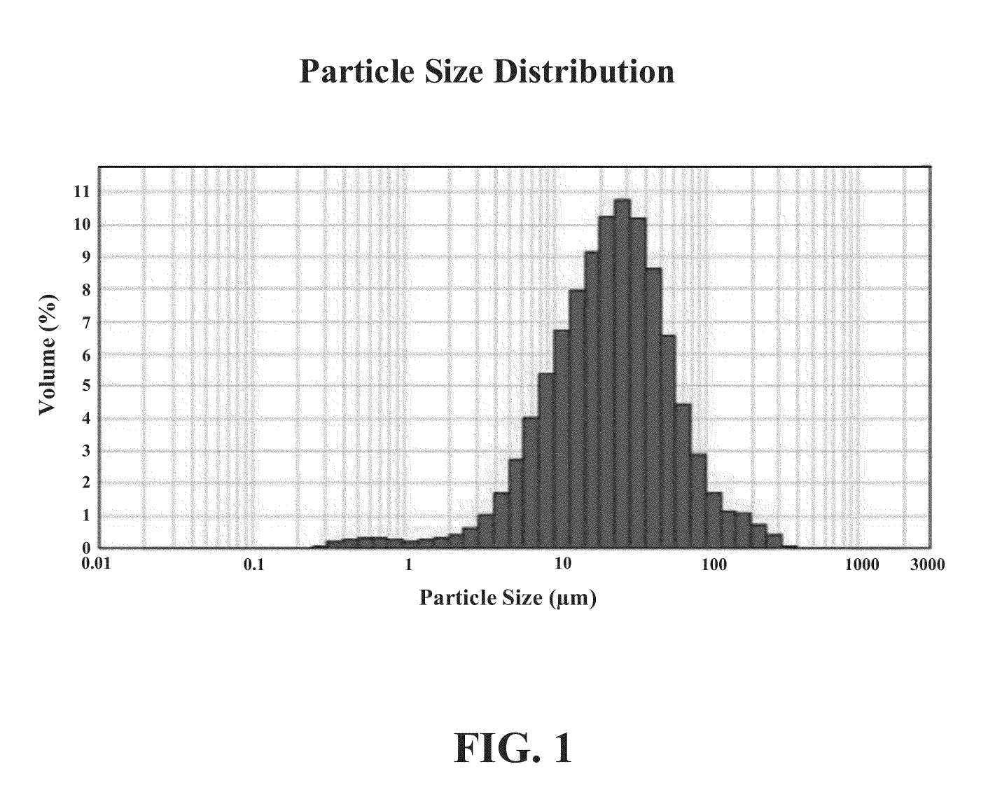

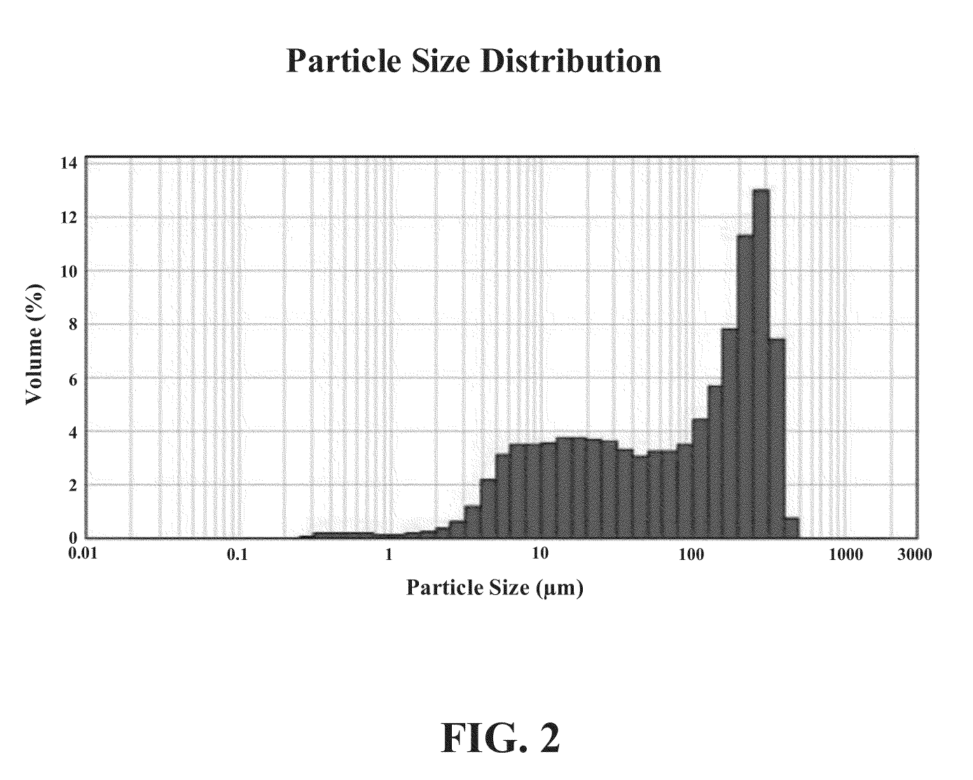

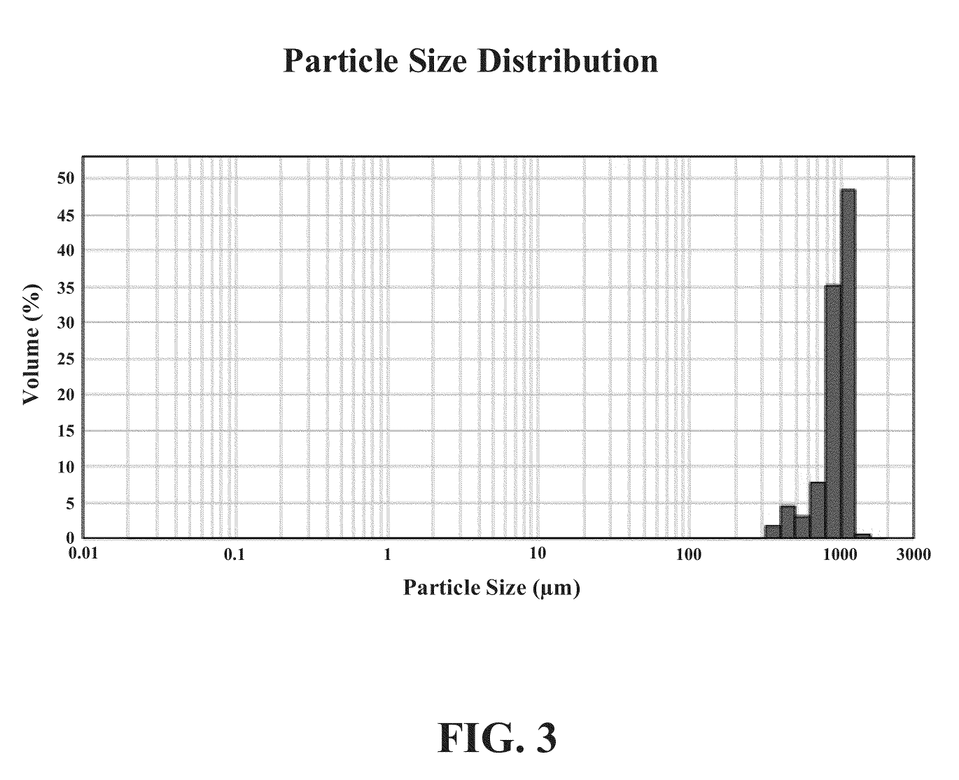

This example illustrates the behavior of three different guar chaff materials Guar LVG (fine), Guar CHURL (medium), and Guar KORMA (coarse) available from Sunita Hydrocolliods Private Limited in model drilling fluids. The fine guar chaff material Guar LVG had the particle size distribution shown in FIG. 1. The medium guar chaff material Guar CHURL had the particle size distribution shown in FIG. 2. The coarse guar chaff material Guar KORMA had the particle size distribution shown in FIG. 3.

Four brine base mud systems or drilling fluids ranging in weight from 11.8 ppg to 12.0 ppg were prepared. Since most water base lost circulation (LCM) materials are used for fresh water drilling fluids, the guar chaff materials were tested in a model brine base mud system or drilling fluid. The first drilling fluid using guar LVG chaff material was formulated at about 13 ppb, but the formulation was too thick to be properly mixed. A second drilling fluid was prepared using 5.2 ppb of the guar LVG chaff material. Three guar chaff materials had no problems generating viscosity in the brine mud system. Thus, the three guar chaff materials or mixtures thereof, are suitable for use in a fresh water based drilling fluids and in brine based drilling fluids.

A blank or comparative brine mud system or drilling fluid was prepared by adding the ingredients listed in Table I at the indicated amounts into a 12 wt. % NaCl brine.

TABLE I
Comparative Brine Drilling Fluid

| | Brine Base Fluid | |
|---|---|---|
| BLANK FORMULATION | SG | Gram |
| 12% NACL, ppb | 1.09 | 326.20 |
| KOH, ppb | 2.06 | 1.25 |
| KCL, ppb | 1.98 | 8.00 |
| WEL PAC LV (Pac) | 1.600 | 3.50 |
| HUMALITE | 1.300 | 6.80 |
| WEL ZAN D (Viscosifier) | 1.55 | 0.80 |
| Barite, ppb | 4.20 | 160.25 |
| Total weight, g | | 506.80 |
| Volume, cc | | 350.00 |
| Mud weight, ppg | | 12.08 |
| SG, g/cc | | 1.448 |

A guar LVG fine chaff material brine mud system or drilling fluid was prepared by adding the ingredients listed in Table II at the indicated amounts into a 12 wt. % NaCl brine.

TABLE II
Comparative Brine Drilling Fluid

| | Brine Base Fluid | |
|---|---|---|
| GUAR LVG (Fine) Formulation | SG | Gram |
| 12% NACL, ppb | 1.09 | 315.26 |
| KOH, ppb | 2.06 | 1.25 |
| KCL, ppb | 1.98 | 8.00 |
| WEL PAC LV (Pac) | 1.600 | 3.50 |
| HUMALITE | 1.300 | 6.80 |
| WEL ZAN D (Viscosifier) | 1.55 | 0.80 |
| Barite, ppb | 4.20 | 160.00 |
| Guar LVG | 0.52 | 5.20 |
| Total weight, g | | 500.81 |
| Volume, cc | | 350.00 |
| Mud weight, ppg | | 11.94 |
| SG, g/cc | | 1.431 |

A guar LVG medium chaff material brine mud system or drilling fluid was prepared by adding the ingredients listed in Table III at the indicated amounts into a 12 wt. % NaCl brine.

TABLE III
Comparative Brine Drilling Fluid

| | Brine base fluid | |
|---|---|---|
| Churl Medium Formulation | SG | Gram |
| 12% NaCl, ppb | 1.09 | 311.48 |
| KOH, ppb | 2.06 | 1.25 |
| KCl, ppb | 1.98 | 8.00 |
| WEL PAC LV (Pac) | 1.600 | 3.50 |
| Humalite | 1.300 | 6.80 |
| WEL ZAN D (Viscosifier) | 1.55 | 0.80 |
| Barite, ppb | 4.20 | 157.00 |
| Guar Churl | 0.76 | 10.80 |
| Total weight, g | | 499.64 |
| Volume, cc | | 350.00 |
| Mud weight, ppg | | 11.91 |
| SG, g/cc | | 1.428 |

A guar chaff coarse material brine mud system or drilling fluid was prepared by adding the ingredients listed in Table IV and the indicated amounts into a 12 wt. % NaCl brine.

TABLE IV
Comparative Brine Drilling Fluid

| | Brine Base Fluid | |
|---|---|---|
| Korma (Coarse) Formulation | SG | Gram |
| 12% NaCl, ppb | 1.09 | 311.20 |
| KOH, ppb | 2.06 | 1.25 |
| KCl, ppb | 1.98 | 8.00 |
| WEL PAC LV (Pac) | 1.600 | 3.50 |
| Humalite | 1.300 | 6.80 |
| WEL ZAN D (Viscosifier) | 1.55 | 0.80 |
| Barite, ppb | 4.20 | 156.32 |
| Guar Korma | 0.74 | 10.80 |
| Total weight, g | | 498.67 |
| Volume, cc | | 350.00 |
| Mud weight, ppg | | 11.89 |
| SG, g/cc | | 1.425 |

The 5.2 ppb fine guar chaff material drilling fluid was thicker than the 10.8 ppb medium guar chaff material drilling fluid, which was thicker than a 10.8 ppb coarse guar chaff material drilling fluid, which was slightly thicker than the blank drilling fluid after 30 minutes of mixing after product addition. These results are tabulated in Table V.

TABLE V
Brine Drilling Fluid Properties and Test Results

| | GUAR FINE | GUAR CHURI | GUAR KORMA |
|---|---|---|---|
| BLANK | 5.2 PPB | 10.8 PPB | 10.8 PPB |
| AFL^{a} 6.2 mL | AFL^{a} 2.8 mL | AFL^{a} 2.7 mL | AFL^{a} 2.7 mL |
| HFL^{b} 16.2 cc | HFL^{b} 10.6 cc | HFL^{b} 10.0 cc | HFL^{b} 10.8 cc |
| Typical dispersed | Very thick gel | Viscous fluid | Slightly more |
| fluid appearance | sweep appearance | appearance | viscous than the |
| | | | Blank |
| SG 1.43 | SG 1.43 | SG 1.41 | SG 1.40 |

^{a}API FLUID LOSS
^{b}HPHT FLUID LOSS

Five grams of Guar LVG (Fine) were added to 150 mL tap water at room temperature. After 48 hours in water, the Guar LVG (Fine) had the appearance of a gel suspension with a slight froth on top.

Five grams of Guar CHURI (Medium) were added to 150 mL tap water at room temperature. After 48 hours in water, the Guar CHURL (Medium) exhibited less viscosity than the fine LVG and some settled chaff material was observed.

Five grams of Guar KORMA (coarse) were added to 150 mL tap water at room temperature. After 48 hours in water, the Guar KORMA (coarse) exhibited less viscosity than the medium GHURI and greater settled chaff material was observed.

The laboratory testing results indicated that the fine guar chaff material, the medium guar chaff material, and the coarse chaff material are suitable for use as LCMs for drilling fluids and pills for managing, reducing or preventing lost circulation in formations having low, moderate and high fluid losses. The guar chaff material performed well in low temperature low pressure fluid loss tests as well as high temperature high pressure fluid loss tests at 250° F. These guar chaff material are non-toxic and biodegradable. The guar chaff material may be size matched to the type of lost circulation encountered. Additionally, the guar chaff material performed well in a brine mud systems. The fine guar chaff material has a particle size that is small enough to be used in an active mud system to prevent seepage losses. As the fine guar chaff material contains residual amount of guar gum, which raises the viscosity of the mud system, the amount of the fine guar chaff material required in fresh water or brine based mud systems is reduced compared to the medium and coarse guar chaff material.

### Example 2

The three grades of chaff material resulting from guar gum productions, guar LVG (Fine), guar CHURL (Medium) and guar KORMA (Coarse), were originally evaluated in a 12% NaCl brine-based fluid. It was concluded that although the Guar LVG and Guar CHURL contained enough residual Guar Gum to greatly increase the fluid viscosity with the addition of the LVG and moderately increase the viscosity with the addition of the CHURL while little effect to the fluid viscosity was observed with the addition of Guar KORMA, all three grades produced lower API fluid loss values and HTHP fluid loss values than the base fluid without the addition of any of the chaff materials (see attached report). That conclusion prompted the decision to perform further testing of the three materials for use as novel types of lost circulation materials.

Addendum test procedures included a Brookfield viscosity comparison of Guar LVG (Fine) to the premium-grade guar gelling agent such as WGA 15. Sand bed plugging tests were also performed to compare a blend of Guar CHURL (Medium) and Guar KORMA (Coarse) to a blend of Walnut Shells (Fine, Medium and Coarse). Test results indicated that with forethought and careful engineering the three grades of Guar Gum chaff can be used to formulate a viscous lost circulation pill. The Guar LVG (Fine) can be used as a low-grade gelling agent with the Guar CHURL (Medium) and Guar KORMA (Coarse) blended together and added to the slurry as Lost Circulation Material.

It became evident from results reported in initial testing that the LVG (Fine) and the CHURL (Medium) materials contained too much residual guar gum to be used as a typical fluid additive to combat lost circulation. Treatment with either of these two materials in quantities sufficient for controlling whole mud losses would generate undesirably high viscosities in a drilling fluid system. Therefore, the viscous lost circulation pill approach was deemed a more suitable use for these materials. Fresh tap water was used for all mixing in the Addendum testing.

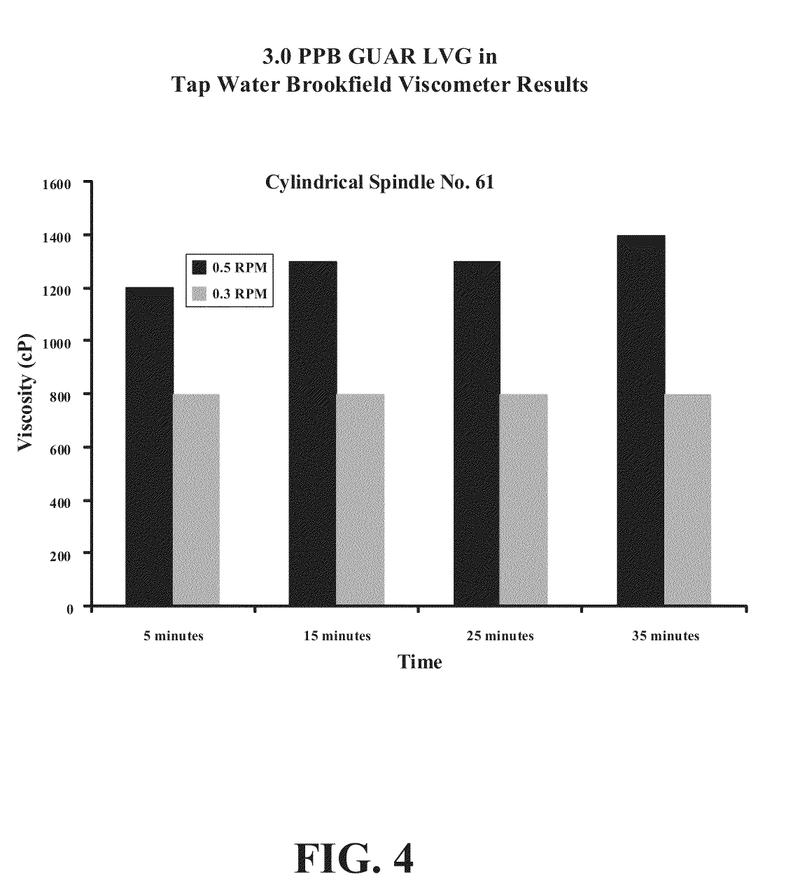

First, slurries of the Guar LVG (Fine) and premium-grade Guar Gum gelling agent such as WGA 15 were prepared at 3.0 ppb. They were each tested on a Brookfield viscometer at 0.3 and 0.5 rpm using a Cylindrical Spindle No. 61. It has been seen that if a drilling fluid system was treated with Guar LVG (Fine) as an LCM additive, too much viscosity would be created throughout the system. However, Brookfield results show that the Guar LVG produces much less viscosity in comparison to the premium-grade guar gelling agent. If the Guar LVG was substituted as the gelling agent for the preparation of a viscous pill, a higher concentration would be required to achieve desired pill viscosities. Test results are listed below in Table VI for the guar LVG material and shown graphically in FIG. 4.

TABLE VI
3.0 PPB Guar LVG in Tap Water Brookfield Viscometer Results

| Time | 0.5 RPM | 0.3 RPM |
|---|---|---|
| 5 minutes | 1200 | 799.8 |
| 15 minutes | 1300 | 799.8 |
| 25 minutes | 1300 | 799.8 |
| 35 minutes | 1400 | 799.8 |

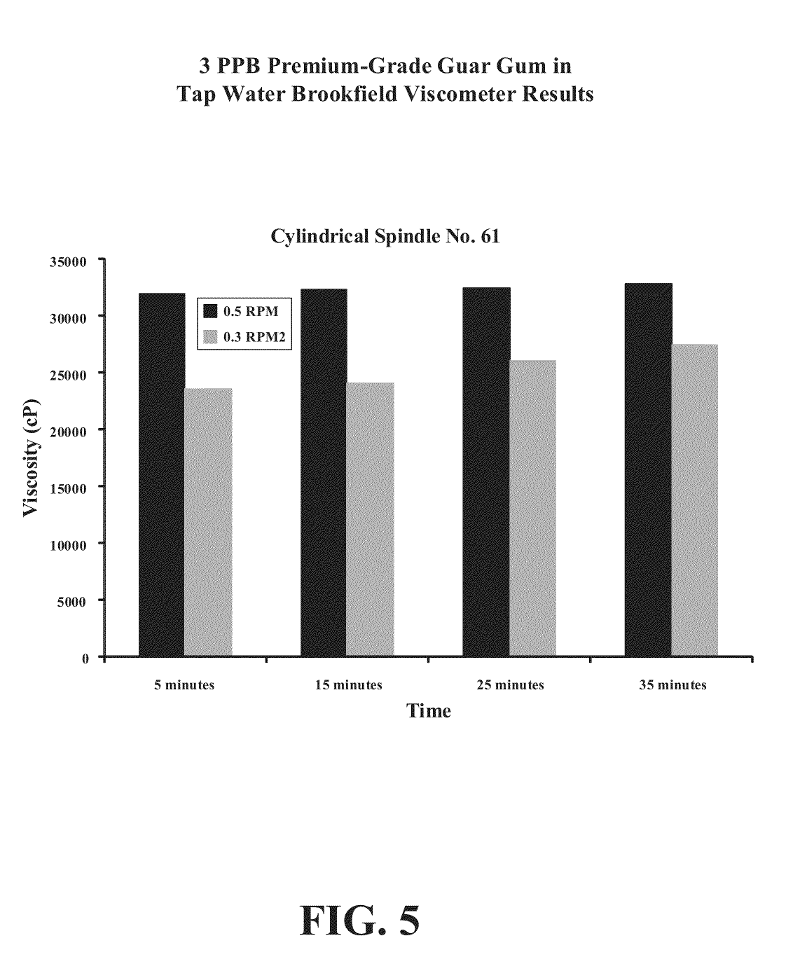

Test results are listed below in Table VII for the premium-grade guar gelling agent and shown graphically in FIG. 5.

TABLE VII
3 PPB Premium-grade Guar Gum Gelling Agent
in Tap Water Brookfield Viscometer Results

| Time | 0.5 RPM | 0.3 RPM |
|---|---|---|
| 5 minutes | 31973 | 23595 |
| 15 minutes | 32393 | 24095 |
| 25 minutes | 32453 | 26094 |
| 35 minutes | 32813 | 27494 |

As a follow-up to the Brookfield viscometer tests, the Guar LVG (Fine) material and premium-grade guar gelling agent were compared by testing Apparent Viscosity (AV) at room temperature (68° F.) on a direct-indicating, rotational viscometer at a product concentration of 3.0 ppb. There was a 56.2% difference between the AV the guar LVG chaff material and the premium-grade guar gelling agent. The apparent viscosity (AV) of a drill fluid including guar LVG (fine) chaff material at 3.0 ppb was measured to be 36.5 cp, while the AV of a drilling fluid including the guar gum WGA 15 gelling agent at 3.0 ppb was measured to be 65.0 cp.

The guar LVG (Fine) chaff material was also compared to the premium-grade guar gelling agent in their ability to build viscosity for use in lost circulation material (LCM) pills using a conventional cross-linking agent.

A 100 mL solution of each material was prepared with an equivalent product concentration of 3.0 ppb (0.86 gm). Each solution was then treated with 5.0 mL of saturated borax (sodium tetraborate) solution. Both solutions readily cross-linked, but the resulting rubber-like mass of the guar LVG (fine) chaff material was not as robust as the premium-grade guar gelling agent.

The following water-based fluid formulation was used to evaluate the Guar CHURL (Medium) as a potential fluid loss control additive in comparison to a starch additive such as WEL-STAR, available from Weatherford.

FLC Additive Evaluation Fluid

| Component | SG | Grams |
|---|---|---|
| Tap Water, ppb | 1.00 | 320.90 |
| Caustic Soda, ppb | 2.10 | 0.25 |
| Soda Ash, ppb | 2.69 | 0.50 |
| Bentonite (WEL-GEL), ppb | 2.40 | 25.00 |
| Lignite (WEL-LIG), ppb | 1.30 | 2.00 |
| *FLC Additive, ppb | 1.47 | 4.00 |
| Glutaraldehyde Biocide, ppb | 1.05 | 0.20 |
| Dispersant (WEL-SPERSE), ppb | 1.30 | 4.00 |
| Lime, ppb | 2.30 | 1.00 |
| Rev Dust, ppb | 2.40 | 25.00 |
| Total Weight, g | | 382.85 |
| Volume, cc | | 350.00 |
| Mud Weight, ppg | | 9.13 |

WEL-GEL, WEL-LIG, and WEL-SPERSE are products available from Weatherford.

The CHURL exhibited heavy foaming during mixing, but it did impart some fluid loss control, even though the starch performed better. The API fluid loss test results for API starch such as WEL-STAR at 4.0 ppb was measured to be 4.6 mL with a 2/32″ thick filter cake. The API fluid loss test results for Guar CHURL (Medium) at 4.0 ppb was measured to be 10.6 mL with a 4/32″ thick filter cake.

The last evaluations performed were some sand bed plugging tests. They were set up to determine if the Guar CHURL (Medium) and Guar KORMA (Coarse) would make effective Lost Circulation Materials when compared to Walnut Shells.

All three grades of Walnut Shells were blended together at 5.0 grams of each. The Guar CHURL and Guar KORMA were blended together at 7.5 grams of each. The Guar LVG was omitted from the LCM blend, but instead, was used in the preparation of base pills for comparison to premium-grade guar gelling agent. Three base pills were mixed at 5.0 ppb Guar LVG (Fine) as well as three base pills at 5.0 ppb premium-grade guar gelling agent. One base pill of each of the products was not treated with a LCM, one base pill of each of the products was treated with 15.0 ppb of the blended Walnut Shells (F,M,C) and the last base pill of each of the products was treated with 15.0 ppb of the blended Guar CHURL (Medium) and Guar KORMA (Coarse).

A standard API filter press was used for the testing. The cells were assembled, as normal, with a screen and API filter paper. They were then filled approximately one-half full with 300 grams of clean, dry 20/40 fracturing sand. The test samples were gently poured down a spatula onto the sand to avoid disturbing the beds. Standard API filtration test parameters of 100 psi for 30 minutes at room temperature were followed. The test results were as follows:

| | | Premium-grade Guar Gelling | |
|---|---|---|---|
| Guar LVG (Fine) Slurry | | Agent Slurry | |
| Blank (No LCM) | 22.2 mL | Blank (No LCM) | 13.8 mL |
| 15.0 ppb Walnut Shells | 12.4 mL | 15.0 ppb Walnut Shells | 13.6 mL |
| (F, M, C) | | (F, M, C) | |
| 15.0 ppb CHURI/ | 6.4 mL | 15.0 ppb CHURI/ | 6.6 mL |
| KORMA | | KORMA | |

All references cited herein are incorporated by reference. Although the invention has been disclosed with reference to its preferred embodiments, from reading this description those of skill in the art may appreciate changes and modification that may be made which do not depart from the scope and spirit of the invention as described above and claimed hereafter.

We claim:

1. A loss circulation additive comprising a guar chaff material having a particle size distribution designed to effectively reduce or prevent loss circulation or effectively reduce or prevent fluid loss into a formation.

2. The additive of claim 1, wherein the guar chaff material comprises a fine guar chaff material, a medium guar chaff material, a coarse guar chaff material or mixtures and combinations thereof, where the fine guar chaff material has a particle size distribution of particles between about 0.5 μm to about 400 μm, the medium guar chaff material has a particle size distribution of particles between about 1 μm to about 700 μm, and the coarse guar chaff material has a particle size distribution of particles between about 100 μm to about 2000 μm.

3. The additive of claim 1, further comprising a viscosity building additive with or without a crosslinking agent.

4. The additive of claim 3, wherein the viscosity building additive comprising a crosslinkable polymer or a plurality of crosslinkable polymers.

5. The additive of claim 3, wherein the viscosity building additive comprises a polyhydroxy polymer or a plurality of polyhydroxy polymers and the crosslinking agent comprise a boron containing compound, a zirconium containing compound, an aluminum containing compound, a chromic containing compound, a titanium containing compound or a mixture thereof.

6. The additive of claim 1, further comprising a base fluid selected from the group consisting of an aqueous base fluid, an oil-in-water emulsion base fluid, an oil-based base fluid, an inverted emulsion base fluid, or a water-in-oil emulsion base fluid.

7. The additive of claim 1, wherein the additive is flexible, softens over time, and/or disintegrates over time.

8. The additive of claim 1, wherein the fluid loss properties are due to viscosity of the resulting fluid or particle size and shape of the additive.

9. The additive of claim 1, wherein the additive has a flake like structure, a portion of the additive is hydratable, and the additive comprises cellulose from the guar seed cover and galactomannan.

10. The additive of claim 9, wherein the additive further comprises proteins.

11. The additive of claim 10, wherein the protein is crosslinkable.

12. The additive of claim 1, wherein the additive is environmental friendly.

13. The additive of claim 1, wherein the additive is a light weight material and reduces a specific gravity of a drilling fluid for underbalanced drilling fluids.

14. The additive of claim 1, wherein the additive further comprises other loss circulation materials selected from the group consisting of walnut shells, cellophane flakes, and mixtures thereof.

15. The additive of claim 1, wherein the additive is a dry powder, a solution in a base fluid, or a slurry in a base fluid.

16. A method of forming a lost circulation fluid comprising the steps of:
providing a lost circulation additive comprising a guar chaff material having a particle size distribution designed to effectively reduce or prevent loss circulation or effectively reduce or prevent fluid loss into a formation; and
contacting the lost circulation additive with a base fluid to form the lost circulation fluid,
where the lost circulation additive is designed to effectively reduce or prevent loss circulation or effectively reduce or prevent fluid loss into a formation.

17. A method of using a lost circulation fluid comprising the steps of:
preparing a loss circulation fluid comprising a loss circulation additive comprising a guar chaff material having a particle size distribution designed to effectively reduce or prevent loss circulation or effectively reduce or prevent fluid loss into a formation; and
circulating the loss circulation fluid downhole to effectively reduce or prevent loss circulation or effectively reduce or prevent fluid loss into a formation.

18. A method of using a lost circulation fluid comprising the steps of:
preparing a drilling fluid comprising a loss circulation additive comprising a guar chaff material having a particle size distribution designed to effectively reduce or prevent loss circulation or effectively reduce or prevent fluid loss into a formation; and
circulating the drilling fluid downhole, while drilling to effectively reduce or prevent loss circulation or effectively reduce or prevent fluid loss into a formation.
